(19) United States
(12) Patent Application Publication
(10) Pub. No.: US 2011/0286306 A1
(43) Pub. Date: Nov. 24, 2011

(54) DETERMINING ORIGIN AND MECHANISM OF MICROSEISMIC EVENTS IN THE EARTH'S SUBSURFACE BY DEVIATORIC MOMENT INVERSION

(76) Inventors: Leo Eisner, Houston, TX (US); Michael P. Thornton, Houston, TX (US)

(21) Appl. No.: 12/784,740

(22) Filed: May 21, 2010

(51) Int. Cl. G01V 1/28

(52) U.S. Cl. 367/47

(57) ABSTRACT

A method for locating origin time, origin location and source mechanism of seismic events occurring in a selected volume of subsurface formations includes calculating a travel time from each possible origin location to each of a plurality of seismic receivers disposed above the volume in a selected pattern. A signal amplitude is measured by each receiver for each possible origin time at each possible origin location. The signal amplitude is determined from the continuously recorded data by calculating travel time delays for each possible origin location and origin time. The deviatoric moment tensors are determined from the signal amplitudes by moment tensor inversion restricted to deviatoric moment tensors. A norm for each deviatoric moment tensor is generated. An origin time, origin position and source mechanism of a seismic event is determined wherein any norm exceeds a selected threshold.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of passive evaluation of seismic events occurring in the subsurface. More specifically, the invention relates to methods for determining origin location, origin time and source mechanism for such seismic events.

2. Background Art

Passive seismic tomography includes disposing seismic sensors above an area of the Earth's subsurface to be evaluated. Seismic data are recorded for a selected length of time and are then processed to determine origin time and origin position of seismic events (typically referred to as “microseismic events”) occurring in the subsurface. A number of processes to perform the evaluation for determining time and place of origin of the events are known in the art.

A general limitation of location determination based on migration type algorithms provides determined locations of microseismic events with much lower signal-to-noise ratios than may otherwise be desirable. For example, passive seismic emission tomographic-type location determination is a migration of compressional wave arrivals at the seismic receivers disposed on the surface or in subsurface wellbores. To cancel noise, migrated traces are stacked to cancel the random noise and enhance signal. Microseismic events caused by shear failure, however generally radiate both positive and negative particle motion and both polarities are typically within the aperture of the set of seismic receivers deployed to measure microseismic events. Thus, simple stacking of migrated receiver signals originating from shear sources leads to cancellation of the signal as positive and negative signals add destructively. Examples and somewhat extensive discussion of this effect is in Chambers K., J-M. Kendall, O. Barkved, 2010: Investigation of induced microseismicity at Valhall using the Life of Field Seismic array, The Leading Edge, pp 290-295. In the foregoing example, where the stacked amplitude of a shear source is only 20, an explosive source's comparative amplitude (with the same strength) is 600 (i.e., 3000% more). Therefore source mechanism correction is necessary for successful migration based location determination.

One way to do such correction is described in Rodriguez I. V., M. D. Sacchi, and Y. J. Gu, 2010: Continuous hypocenter and source mechanism inversion via a Green's function-based matching pursuit algorithm, The Leading Edge, pp 334-337. In the foregoing publication, for each potential microseismic source location and origin time the source mechanism is inverted by a damped least square inversion of the full mechanism. Then the source location (and mechanism) is determined as a maximum norm of the moment tensor (similar to maximum amplitude of stack described in, Chambers et. al. (2010).

The main drawback of the foregoing approaches is the need for a priori estimation of the damping parameter. In addition, some types of seismic sources result in a trade-off between depth and maximum norm of unconstrained moment (i.e., an isotropic source). For any isotropic source a deeper location (than the true source location depth) will have larger norm of the moment, thus resulting in location determination artifacts.

There continues to be a need for improved source position and mechanism determination from microseismic signal detection.

### SUMMARY OF THE INVENTION

A method according to one aspect of the invention for locating origin time, origin location and source mechanism of seismic events occurring in a selected volume of subsurface formations includes calculating a travel time from each possible origin location to each of a plurality of seismic receivers disposed above the volume in a selected pattern. A signal amplitude is measured by each receiver for each possible origin time at each possible origin location. The signal amplitude is determined from the continuously recorded data by calculating travel time delays for each possible origin location and origin time. A inversion of moment tensor is carried out through converting moment tensor to vectors and constraining to deviatoric moment tensors (or vector). A norm for each deviatoric moment tensor is generated. An origin time, origin position and source mechanism of a seismic event is determined wherein any norm exceeds a selected threshold.

Other aspects and advantages of the invention will be apparent from the following description and the appended claims.

### BRIEF DESCRIPTION OF THE DRAWINGS

FIG. 1 shows an example deployment of seismic receivers over a volume of the subsurface to be analyzed.

FIG. 2 shows a flow chart of an example method according to the invention.

FIG. 3 shows a programmable computer and computer readable storage media.

### DETAILED DESCRIPTION

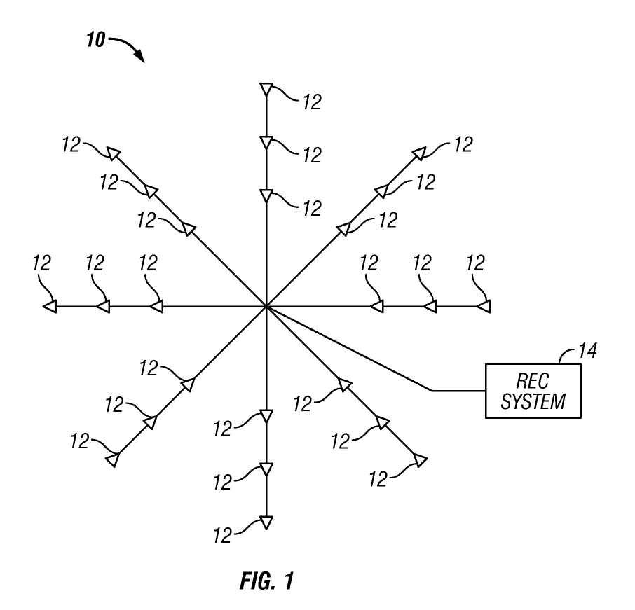

FIG. 1 shows an example seismic receiver array 10 disposed above an area (volume of the subsurface to be evaluated. A plurality of seismic receivers 12 such as accelerometers, velocity meters or geophones is arranged in a selected pattern above the area. The receivers generate electrical or optical signals related to seismic amplitude. Such signals are conducted to a recording unit 14 which includes equipment well known in the art for making time indexed recordings of the signals generated by the receivers 12. While the array 10 is shown in a hub and spoke form, other geometric arrangements of the array 10 may be used in different examples.

In general, methods according to the invention process the recorded signals from the array to determine locations of, times of and source mechanisms of seismic events occurring in the subsurface volume. Examples of the present method may overcome limitations of prior techniques for source location and mechanism determination by inverting the receiver signals for every potential location in the subsurface volume and origin time for deviatoric (zero-trace) moment tensors with or without least square damping. Then the norm of each inverted deviatoric moment tensor is determined and if a maximum norm above a certain threshold (e.g., the maximum of the norms is twice as large as an average of the norms) is determined, such deviatoric tensor will identify a potential source location. This potential location can be further verified or rejected by testing a vertical dependency of this maximum norm (analogous to derivations of families in U.S. Pat. No. 7,663,970 issued to Duncan et al. and assigned to the assignee of the present invention).

A possible advantage of using the deviatoric moment is speed of the inversion. The deviatoric moment can be inverted by linear inversion. This advantage is shared with full moment tensor inversion (but not shear moment tensor), but the additional advantage of restricting the source mechanism to being deviatoric is that it does not suffer from spurious high values of the moment norm that project into to the trace of the full moment tensor. Therefore it is possible to carry out an inversion procedure for deviatoric moment without damping.

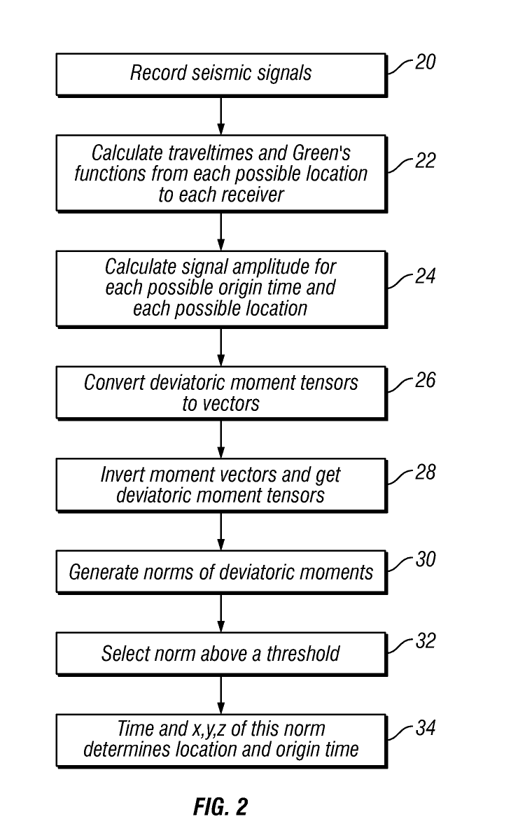

Referring to FIG. 2, in a specific example of inversion of the deviatoric moment, assume there are time indexed recorded seismic amplitude curves (“traces”) shown at 20, S, for a number, N, of vertical components of seismic receivers in the array (10 in FIG. 1). Vertical components may be obtained by using the vertical component of multicomponent seismic receivers (12 in FIG. 1), or single component receivers may be used instead. The signal at each receiver (12 in FIG. 1) may thus be represented by S(i, t), where i=1 . . . N (the i-th receiver) and t is time. Then for each potential event origin (seismic source) position j a (P-wave or S-wave) travel time can be calculated, shown at 22, from the potential source portion to the position of each receiver i: It is assumed for purposes of this description that a reasonably accurate knowledge of seismic (compressional in the case of P-waves) velocity distribution from the surface to the volume has been obtained, such as by calibration shot (string shot) or conventional reflection seismic migration velocity analysis. Then for every possible origin time T₀ the corresponding recorded signal amplitude Aᵢ=S(i, T₀+Tⱼᵢ) can be related to the moment tensor shown at 24. These amplitudes are related through the corresponding derivatives of Green's function calculated in the velocity model (the same model used for calculating travel times) for each source-receiver pair shown at 26. The derivatives of Green's function Gᵢₖₗ, in which k and l denote the source components and i denotes the receiver components. Then amplitudes from a moment tensor Mₖₗ can be written as:

Aᵢ=GᵢₖₗMₖₗ (1)

For a deviatoric moment tensor, trace zero or Mₓₓ+M_{yy}+M_{zz}=0, thus one can express Mₓₓ+M_{yy}=−M_{zz} and rewrite equation (1) above without the M_{zz} component, and by converting moment tensor Mₖₗ to a moment vector mₙ, as shown at 26:

Aᵢ=G′ᵢₘm′ₘ (2)

Amplitude Ai can be inverted using, for example, least squares inversion, as shown at 28:

m′ₙ=(G′ᵢₙG′ₙᵢ)⁻¹G′ₙᵢAᵢ. (1)

Thus one can obtain, for every possible source location in the subsurface area of evaluation and for every possible origin time, the deviatoric moment tensor components (mₙ), and the largest eigenvalue of such deviatoric moment tensor can be a norm of the corresponding moment tensor (M′), as shown at 30. The foregoing norms are evaluated in the space of all potential source locations and for selected time intervals (e.g. 1 second). A maximum can be found within such constraints and compared to an average of the norms. If the maximum is significantly above (e.g., a selected threshold) an average corresponding origin time and source location norm, as shown at 32, then the maximum may be deemed to be the origin time and source location of a microseismic event, as shown at 32. Origin time, source location and source mechanism of the events so calculated by be displayed, for example on a printed plot or a computer display.

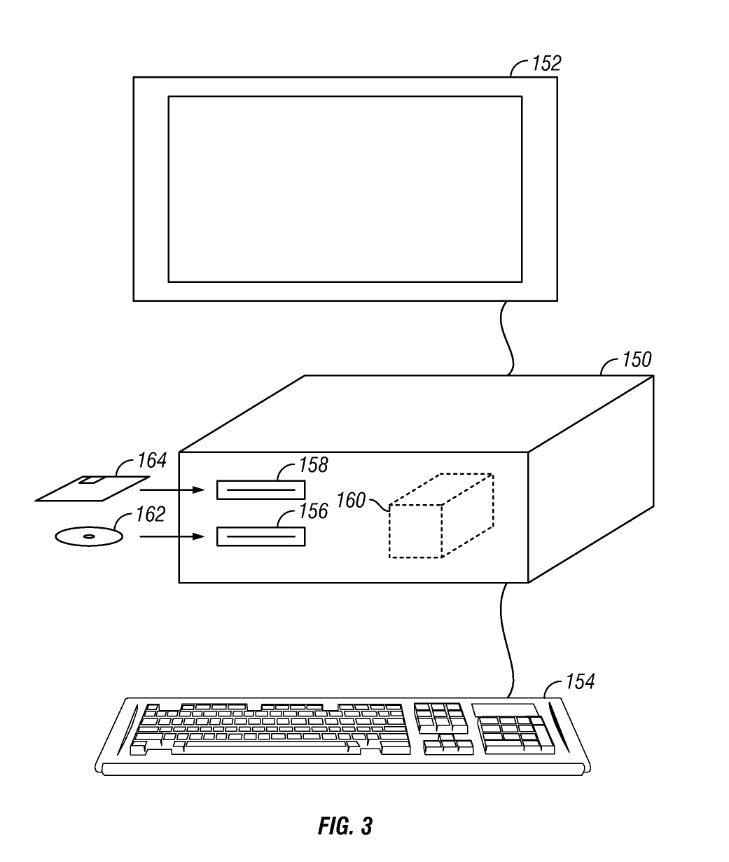

In another aspect, the invention relates to computer programs stored in computer readable media. Referring to FIG. 3, the foregoing process as explained with reference to FIGS. 1-2, can be embodied in computer-readable code. The code can be stored on a computer readable medium, such as floppy disk 164, CD-ROM 162 or a magnetic (or other type) hard drive 166 forming part of a general purpose programmable computer. The computer, as known in the art, includes a central processing unit 150, a user input device such as a keyboard 154 and a user display 152 such as a flat panel LCD display or cathode ray tube display. The computer may form part of the recording unit (14 in FIG. 1) or may be another computer. According to this aspect of the invention, the computer readable medium includes logic operable to cause the computer to execute acts as set forth above and explained with respect to the previous figures. The user display 152 may also be configured to show hypocenter locations and fracture networks determined as explained above.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for locating origin time, origin location and source mechanism of seismic events occurring in a selected volume of subsurface formations, comprising
calculating a travel time from each possible origin location to each of a plurality of seismic receivers disposed above the volume in a selected pattern;
calculating a signal amplitude for the signal measured by each receiver for each possible origin time at each possible origin location;
inverting deviatoric moment tensors determined from the signal amplitudes;
generating a norm for each deviatoric moment tensor; and
selecting an origin time, origin position and a source mechanism of at least one seismic event wherein any norm exceeds a selected threshold.

2. The method of claim 1 wherein the norm comprises maximum eigenvalue.

3. The method of claim 1 wherein the selected threshold comprises an average of the norms.

4. The method of claim 1 wherein the inverting deviatoric moment tensors comprises linear least squares inversion.

5. A method for passive seismic evaluation of a selected volume of the Earth's subsurface, comprising:
deploying an array of seismic receivers above the selected volume in a selected pattern;
recording signals generated by the receivers for a selected time;
calculating a travel time from each possible origin location to each of the seismic receivers;
calculating a signal amplitude for the signal measured by each receiver for each possible origin time at each possible origin location;
inverting deviatoric moment tensors determined from the signal amplitudes;
generating a norm for each deviatoric moment tensor; and
selecting an origin time, origin position and a source mechanism of at least one seismic event wherein any norm exceeds a selected threshold.

6. The method of claim 5 wherein the norm comprises maximum eigenvalue.

7. The method of claim 5 wherein the selected threshold comprises an average of the norms.

8. The method of claim 5 wherein the inverting deviatoric moment tensors comprises linear least squares inversion.
